(19) United States
(12) Patent Application Publication
(10) Pub. No.: US 2025/0058703 A1
(43) Pub. Date: Feb. 20, 2025

(54) OBDII TRAILER TOWING WIRELESS LIGHT KIT

(71) Applicant: Ernest Everett Owens, JR., federal heights, CO (US)

(72) Inventor: Ernest Everett Owens, JR., federal heights, CO (US)

(21) Appl. No.: 18/234,323

(22) Filed: Aug. 15, 2023

(51) Int. Cl. B60Q 1/30; B60D 1/64; B60Q 1/34; B60Q 1/44

(52) U.S. Cl. CPC B60Q 1/305; B60D 1/64; B60Q 1/34; B60Q 1/44; B60Q 2900/30

(57) ABSTRACT

A device which allows the user to tow a trailer wirelessly by, plugging a radio frequency transmitter into the vehicle and by plugging a radio frequency receiver into the towed trailer, for brake lights, tail lights and turn signals.

### Field

The present application relates to a device that allows the user to Tow a trailer with wireless attachments for trailer lights. Particularly Brake lights, tail lights, and turn signals.

### BACKGROUND

The Trailer Towing Industry for years and to this very day are cutting into wire harnesses of automobiles for the purpose of achieving light signals for towed trailers. The recent trend of new electric Cars has aggravated this wire splicing problem.

### SUMMARY

By providing a device that allows light signals to be sent to a Towed Trailer wirelessly as described by the embodiments will stop splicing of automobiles wiring harnesses and stop dragging trailer cords.

This disclosed exemplary embodiment provides a device to send light signals directly to a Towed Trailer for lights wirelessly. Further objects, features advantages and properties of device according to the present application will become apparent from the detailed descriptions. It should be noted that although only a Code Reader/Sender/Receiver is described the teachings of this application can also be used on Trailers with electric brakes. Although the invention has been understood many other possible modifications and variations can be made without departing from the spirit and scope of this invention as hereinafter claimed.

### DESCRIPTION OF DRAWINGS

In the following detailed portion of the present application will be explained in more detail with reference to the example embodiments shown in the drawings in which

FIG. 1 is a view of a device according to a first embodiment

FIG. 2 is a view of a device according to a second embodiment

FIG. 3 is a view of a device according to a third embodiment

FIG. 4 is a view of a device according to a fourth embodiment

FIG. 5a is a view of where to Insert the new invention

FIG. 5b is a view of the RF Senders Plastic Housing

FIG. 6 is a view of RF Receiver Plastic Housing

### DETAILED DESCRIPTION

In the following detailed description, the Device according to the teachings for this Application in the form of a OBDII Automotive Code Reader/Sender/Receiver show how this OBDII Reader/Transmitter works.

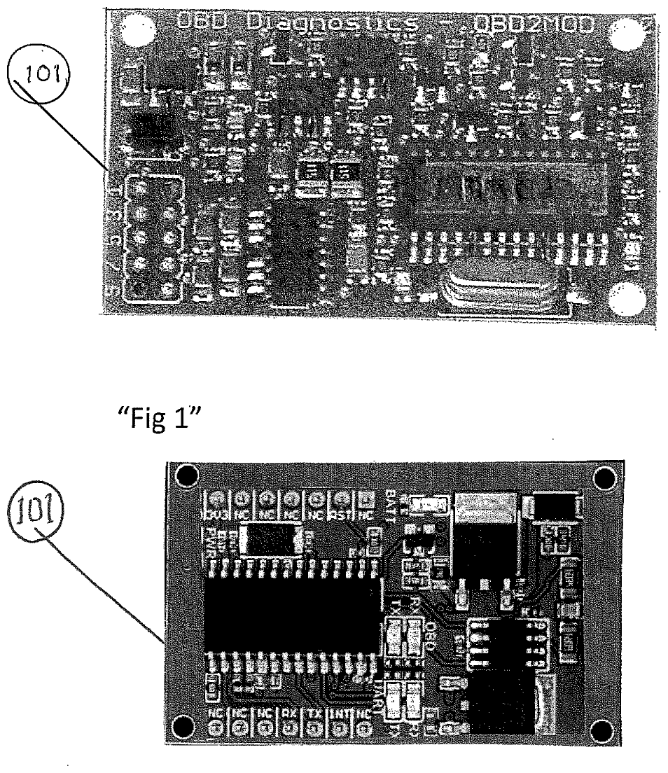

A first embodiment of the On Board Diagnostic Board is illustrated in FIG. 1. The Diagnostic Board a blank programable serial can bus module with interface connector 16 pin 1 Mb rate then coded to read the light signals from the automobiles on board computer, through the on board diagnostic port. A wireless communication module with real time signal data, integrated radio transmitter, modem/32 bit 48 MHz operation continuous frequency coverage from 150 MHz to 840 MHz 12 volt power supply from automobiles OBD port 16 pin 1 Mb rate.

The internal components, software and coded protocol structure of the On Board Diagnostic Reader/Sender will not be described in detail since such technology is generally well known. However, the coded board is adapted to the shape of the automobiles On Board Diagnostic Port.

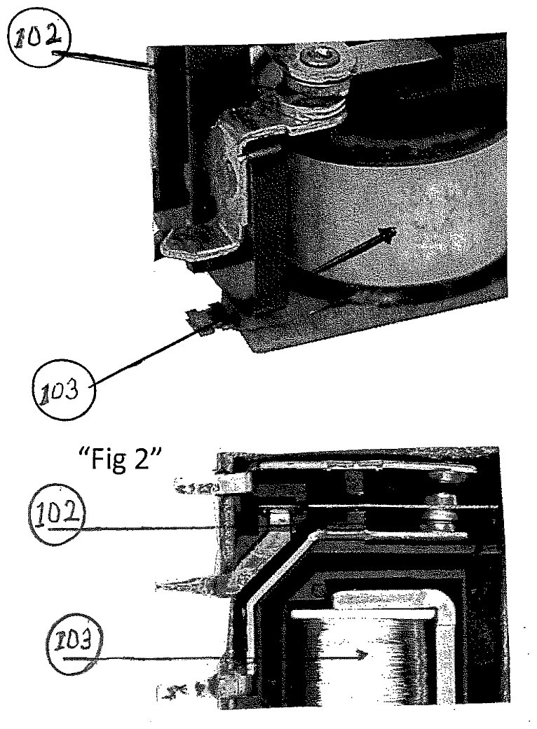

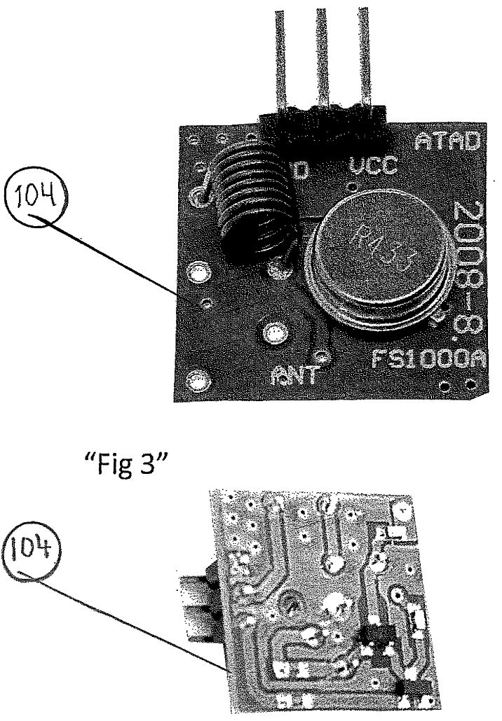

A second embodiment of the On Board Diagnostic Component is illustrated in FIG. 2. A 12/Volt miniature electromagnetic relays captures and converts electrical signals from Diagnostic Board and sends signals to Radio Transmitter Can Bus module with interface connector. A third embodiment of the component is illustrated in FIG. 3. Radio Transmitter send signals on 48 MHz operating frequency 32/bit continuous coverage from 15 MHz to 840 MHz. Power Supply is from the on board diagnostic port. Light signals are sent to the receiver. The internal Component, software and protocol structure of the radio frequency transmitter technology is generally known.

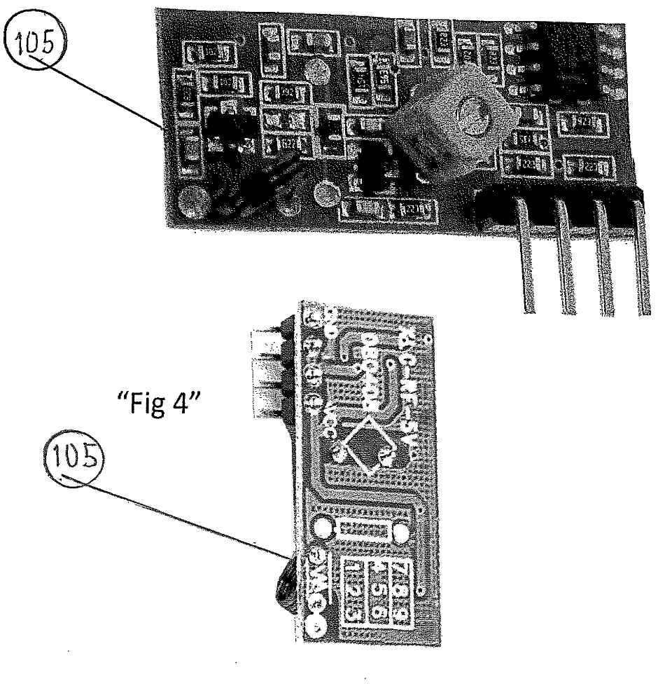

A fourth embodiment of the On Board Diagnostic Receiver is illustrated in FIG. 4 a radio frequency wireless receiver to receive light signals for a towed trailer at 48 MHz operating frequency. Power supply from a 12 volt re-chargeable batter pack.

1: (canceled)

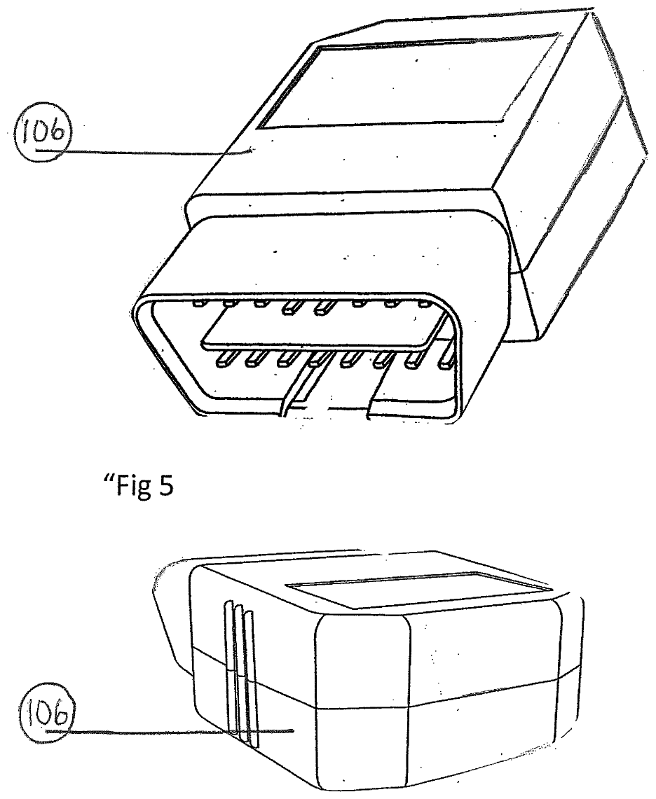

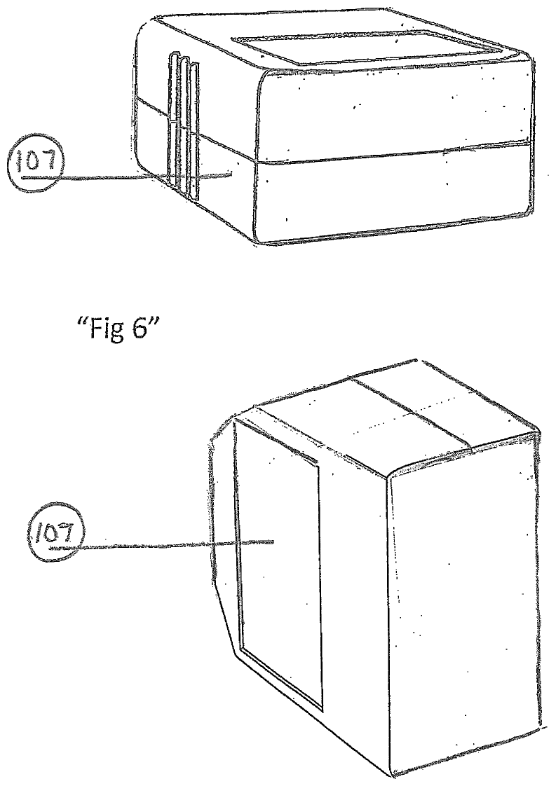

2: New an OBDII trailer towing wireless light kit comprising:
element a; A device according to claim 2
Wherein a miniature 2.25×1.25 OBD Diagnostic Programable Board FIG. 1 page 5 101 serial can bus module with interface 16 pin real time data is coded to receive, Brake light, Tail light and turn signals from the automobiles OBD port.
element b; A device according to claim 2
Wherein a miniature 0.025×0.025×0.025 12 volt electromagnetic relay FIG. 2 page 6 102/103 attached to element a; FIG. 1 page 5 101 to receive light signals from the coded miniature OBD Diagnostic board FIG. 1 page 5 101 then relays electrical light signals to element c; FIG. 3 page 7 104.
element c; A device according to claim 2
Wherein a miniature 1.5×1.75 continuous coverage 48 MHZ 32 bit transmitter FIG. 3 page 7 104 is attached to the OBD diagnostic board FIG. 1 page 5 101 to capture real time signal data from element b; FIG. 2 page 6 102/103 then transmits light signals wirelessly to element d; page 8 105 element d; A device according to claim 2
Is a miniature 1.75×3.50 continuous coverage real time data 48 MHZ 32 bit RF Radio Receiver FIG. 4 page 8 105 receives light signals wirelessly from element c; FIG. 3 page 7 104
element e; A device according to claim 2
Is a OBDII molded plastic housing 5.75×1.25×3.75 FIG. 5 page 9 106 that contains FIG. 1 101, FIG. 2 102/103 and FIG. 3 104 molded to fit automobiles OBD Port.
element f; A device according to claim 2
Is a molded plastic housing 3.50×2.95×1.25 contains real time data RF Radio receiver 48 MHZ 32 bit continuous coverage FIG. 6 page 10 107 forwards lights signals to towed trailer wirelessly.
